(19) United States
(12) Patent Application Publication
(10) Pub. No.: US 2021/0370479 A1
(43) Pub. Date: Dec. 2, 2021

(54) VACUUM SUCTION DEVICE

(71) Applicant: Century Technology (Shenzhen) Corporation Limited, Shenzhen (CN)

(72) Inventor: CONG-JIAN LUO, Shenzhen (CN)

(21) Appl. No.: 17/036,432

(22) Filed: Sep. 29, 2020

(30) Foreign Application Priority Data
May 29, 2020 (CN) 202010477698.1

(51) Int. Cl. B25B 11/00

(52) U.S. Cl. CPC B25B 11/005

(57) ABSTRACT

A soft-acting and non-deforming vacuum suction device includes a vacuum generating structure and a suction head. The suction head includes a positioning block and a suction nozzle. The positioning block defines a through hole. The vacuum generating structure is open to the through hole, so that the nozzle pulls on or releases a workpiece by creating or releasing the vacuum of the through hole. When the workpiece to be transferred is pulled to the suction nozzle, the workpiece abuts softly against a first surface of the positioning block.

### FIELD

The subject matter herein generally relates to suction devices.

### BACKGROUND

A workpiece such as a glass substrate for a liquid crystal display panel can be transferred to a target position on an operating platform by a grabbing device. However, the transfer process is not smooth, the workpiece may be shaken and stressed due to the elasticity and resonance of a vacuum element grabbing the workpiece. As a result, the workpiece may be deformed or damaged, and the accuracy of transfer of the workpiece to the target position is reduced.

Therefore, there is room for improvement in the art.

### BRIEF DESCRIPTION OF THE DRAWINGS

Implementations of the present disclosure will now be described, by way of embodiment, with reference to the attached figures.

FIG. 1 is a planar view of a vacuum suction device according to an embodiment when a workpiece is lifted.

FIG. 2 is an isometric view showing part of the vacuum suction device in FIG. 1.

FIG. 3 is a cross-sectional view along line II-II of FIG. 1.

FIG. 4 is a cross-sectional view of the vacuum suction device at rest according to an embodiment.

FIG. 5 is a cross-sectional view of a vacuum suction device according to related art when the workpiece is lifted.

FIG. 6 is a cross-sectional view of the vacuum suction device in use according to an embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”.

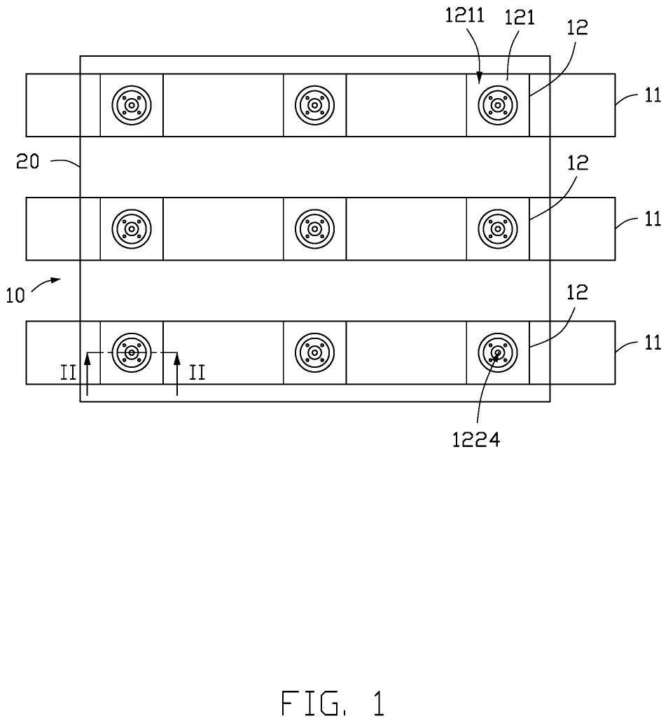

FIG. 1 shows a vacuum suction device 10 according to an embodiment, the device 10 can lift and move a workpiece 20. The vacuum suction device 10 generates suction force by creating a vacuum to lift the workpiece 20 and transfer the workpiece 20 to a target position. The vacuum suction device 10 is suitable for thin and plate-shaped workpieces 20, for example, the transfer of glass substrates for liquid crystal display panels. The target position is, for example, a preset position on an operating platform.

As shown in FIG. 1, the vacuum suction device 10 includes at least one transfer arm 11. In one embodiment, the vacuum suction device 10 includes three transfer arms 11. The transfer arms 11 are arranged in parallel and spaced apart from each other. A distance between adjacent transfer arms 11 is equal. The transfer arms 11 are sized and positioned to be uniformly distributed on a surface of the workpiece 20, deformity and damage to the workpiece are thereby prevented.

As shown in FIG. 1, at least one suction head 12 is fixed on each transfer arm 11. In one embodiment, three suction heads 12 are fixed on each transfer arm 11. On each transfer arm 11, a distance between adjacent suction heads 12 is equal.

In other embodiments, quantity of transfer arms 11 and quantity of the suction heads 12 on each transfer arm 11 can be adjusted according to the actual needs. The number of suction heads 12 on each transfer arm 11 can be different. The distance between adjacent transfer arms 11 can be unequal and the distance between adjacent suction heads 12 can be unequal. In other embodiments, each suction head 12 is detachably attached to the transfer arm 11, so that the number of suction heads 12 can be selected according to a size of the workpiece 20.

As shown in FIG. 1, the vacuum suction device 10 creates the suction force, an end of each suction head 12 away from the transfer arm 11 thus attracts and holds the workpiece 20. The transfer arms 11 move synchronously to keep their relative positions constant as the workpiece 20 is transferred to the target position. The displacement of each transfer arm 11 can be controlled by an external motor (not shown).

Each suction head 12 in the vacuum suction device 10 has the same structure, and the structure of one of the suction heads 12 is described.

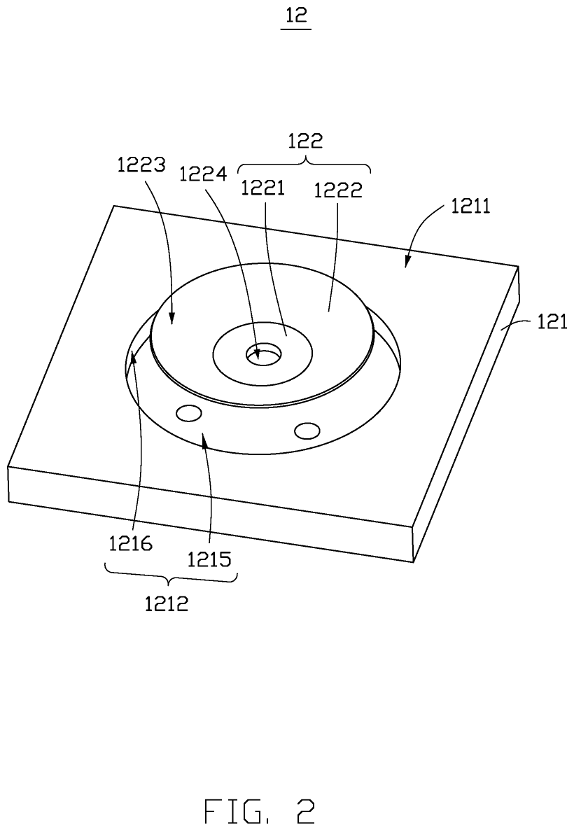

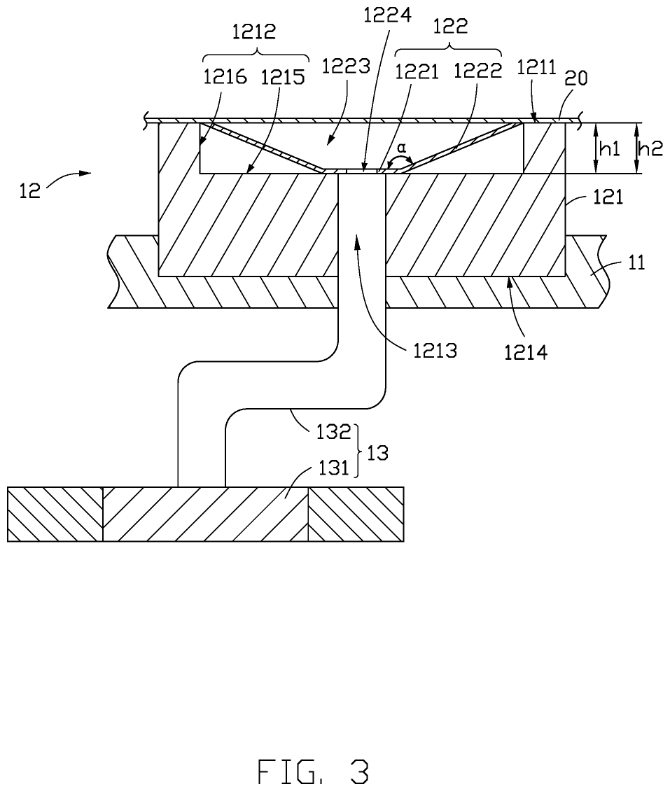

As shown in FIGS. 2 and 3, the suction head 12 includes a positioning block 121 on the transfer arm 11 and a suction nozzle 122 fixed on the positioning block 121.

As shown in FIG. 2, the positioning block 121 is a quadrangular prism. In other embodiments, the positioning block 121 may have other shapes, such as cylindrical, pentagonal, truncated, and the like.

As shown in FIGS. 2 and 3, the positioning block 121 has a first surface 1211 away from the transfer arm 11 and a second surface 1214 opposite to the first surface 1211. The first surface 1211 defines an accommodating groove 1212. The accommodating groove 1212 has a bottom wall 1215 and a side wall 1216 perpendicularly connected to the bottom wall 1215. The bottom wall 1215 is away from the first surface 1211. The side wall 1216 has a constant height along its length.

As shown in FIG. 3, a height of the side wall 1216 (i.e., a depth of the accommodating groove 1212) is defined as h1. The positioning block 121 defines a through hole 1213 extending through the first surface 1211 and the second surface 1214. The through hole 1213 opens to the accommodating groove 1212.

In one embodiment, a material of the suction nozzle 122 is a flexible and deformable material, such as silicone or rubber.

As shown in FIG. 3, the suction nozzle 122 is at least partially accommodated in the accommodating groove 1212. The suction nozzle 122 is substantially bowl-shaped. The suction nozzle 122 has a bottom portion 1221 fixed on the bottom wall 1215 and a side portion 1222 connected to the bottom portion 1221. The bottom portion 1221 of the suction nozzle 122 and the side portion 1222 of the suction nozzle 122 intersect to form an obtuse angle α. That is, the side portion 1222 is obliquely (non-vertically) connected to the bottom portion 1221. The bottom portion 1221 is a flat plate, and the side portion 1222 is curved in an arc shape. The bottom portion 1221 defines a first opening 1224. The first opening 1224 is aligned with the through hole 1213. That is, the first opening 1224 exposes the through hole 1213. The bottom portion 1221 and the side portion 1222 enclose a hollow structure. The second opening 1223 is at an end of the side portion 1222 away from the positioning block 121.

As shown in FIGS. 2 and 3, the bottom portion 1221 is substantially circular. In other embodiments, the bottom portion 1221 may have other shapes, such as a square or irregular shape.

As shown in FIG. 3, the suction nozzle 122 pulls the workpiece 20 onto the second opening 1223, and the workpiece 20 acts to seal the second opening 1223. A vertical distance between an end of the side portion 1222 away from the bottom portion 1221 and the bottom wall 1215 of the accommodating groove 1212 is defined as h2.

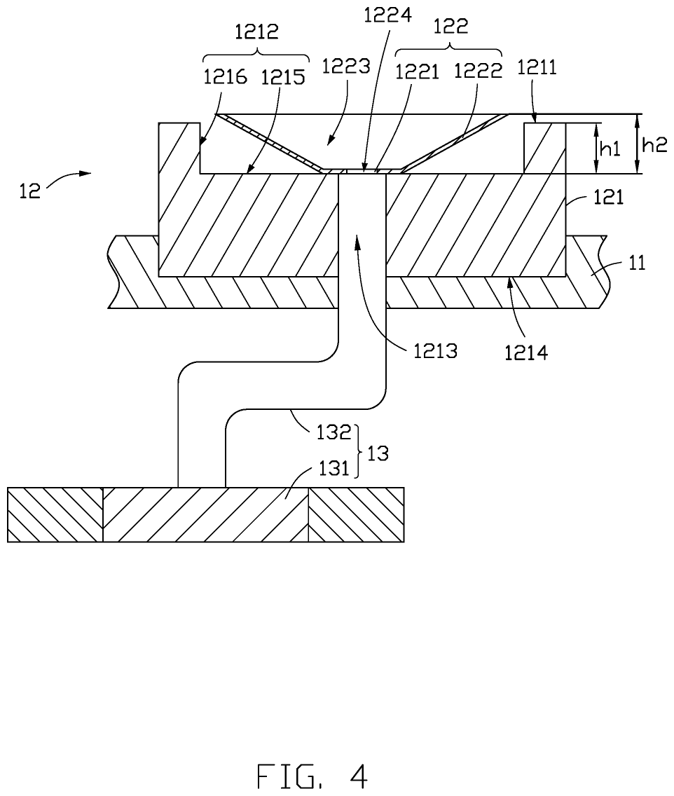

As shown in FIG. 4, the suction head 12 does not pull the workpiece 20, the suction nozzle 122 protrudes from the accommodating groove 1212, and the second opening 1223 protrudes from the accommodating groove 1212. That is, h2 is greater than h1. In one embodiment, height difference between h2 and h1 is 0.1 mm. In other embodiments, the height difference between h2 and h1 may be different and may be determined according to parameters such as weight of the workpiece 20 and compressibility of the suction nozzle 122.

As shown in FIG. 3, when the suction head 12 pulls the workpiece 20, the suction nozzle 122 shrinks toward the positioning block 121, and the second opening 1223 of the suction nozzle 122 is at the same height as the first surface 1211 of the positioning block 121. A surface of the workpiece 20 close to the suction head 12 abuts against the first surface 1211 of the positioning block 121.

In one embodiment, the vacuum suction device 10 has a plurality of suction heads 12. When the vacuum suction device 10 pulls the workpiece 20, the surface of the workpiece 20 close to the suction heads 12 is against the first surface 1211 of the positioning block 121 of each suction head 12.

Due to resistance of the first surface 1211, a uniform force is applied to the workpiece 20. Therefore, the workpiece 20 is not deformed or damaged. Each adsorption head 12 has the same structure, and each positioning block 121 has the same height. Therefore, when the surface of the workpiece 20 close to the suction head 12 and the first surface 1211 of each positioning block 121 abut against each other, the workpiece 20 is fixed on the plane where the first surface 1211 of each positioning block 121 is located. The workpiece 20 is kept stable during the process of transferring the workpiece 20 and shaking and resonance due to contraction of the suction nozzle 122 is avoided, thereby improving the accuracy of the transfer to the target position.

As shown in FIG. 3, the vacuum suction device 10 includes at least one vacuum generating structure 13. In one embodiment, the vacuum suction device 10 includes three vacuum generating structures 13 (only one is shown in FIG. 3). Each vacuum generating structure 13 is open to the through holes 1213 in the suction heads 12 on the same transfer arm 11, so that the suction nozzle 122 pulls or releases the workpiece 20 by applying or releasing the vacuum in the through hole 1213.

In other embodiments, quantity of vacuum generating structures 13 in the vacuum suction device 10 can be adjusted according to the actual needs. Each vacuum generating structure 13 may be open to the through hole 1213 of the suction head 12 on different transfer arms 11. Quantity of through holes 1213 connected to each vacuum generating structure 13 may be different, and the number of through holes 1213 open to each vacuum generating structure 13 is one or more.

In one embodiment, the vacuum generating structure 13 is open to the through holes 1213 of the plurality of adsorption heads 12. The different distances between the suction heads 12 and the vacuum generating structure 13 lead to different times being required for the vacuum-creation or vacuum-releasing processes of the suction heads 12, which may affect the suction effect. Therefore, in an actual commercial operation, the number of through holes 1213 in the suction head 12 connected to each vacuum generating structure 13 and the relative positions of each suction head 12 and the vacuum generating structure 13 need to be calculated according to the operation.

As shown in FIG. 3, each vacuum generating structure 13 includes a vacuum solenoid valve 131 and a connecting pipe 132 connected with the solenoid valve 131. Each vacuum solenoid valve 131 is connected to a vacuum pump (not shown) to control creation and release of vacuum. One end of the connecting pipe 132 is connected to the solenoid valve 131, and the other end of the connecting pipe 132 is open to the through hole 1213 of the suction head 12. When the second opening 1223 on the suction nozzle 122 is closed by the workpiece 20, the connecting pipe 132, the through hole 1213, and the space between the first opening 1224 and the second opening 1223 of the suction nozzle 122 constitute a closed space. When the solenoid valve 131 is evacuated, a vacuum directed from the second opening 1223 to the first opening 1224 is generated, thereby fixing the workpiece 20 to the suction nozzle 122.

As shown in FIGS. 3 and 4, the working process of the vacuum suction device 10 is described below.

Before the suction head 12 is activated, the end of the suction nozzle 122 with the second opening 1223 protrudes from the accommodating groove 1212. The workpiece 20 gradually approaches the second opening 1223 of the suction head 12. When the distance between the workpiece 20 and the second opening 1223 of the suction head 12 is less than or equal to a preset value, the vacuum generating structure 13 starts to work. The workpiece 20 is in direct contact with the suction nozzle 122, and the workpiece 20 closes the second opening 1223. The mass of the workpiece 20 and the vacuum generated by the vacuum generating structure 13 cause the suction nozzle 122 to deform and shrink toward the positioning block 121 until the workpiece 20 abuts the first surface 1211 of the positioning block 121. The transfer arm 11 transfers the workpiece 20 to the target position. The vacuum created by the vacuum generation structure 13 is released, the suction force of the suction nozzle 122 on the workpiece 20 ceases, and the workpiece 20 is separated from the suction nozzle 122.

In other embodiments, the vacuum generating structure 13 may start to work after the workpiece 20 closes the second opening 1223, saving energy.

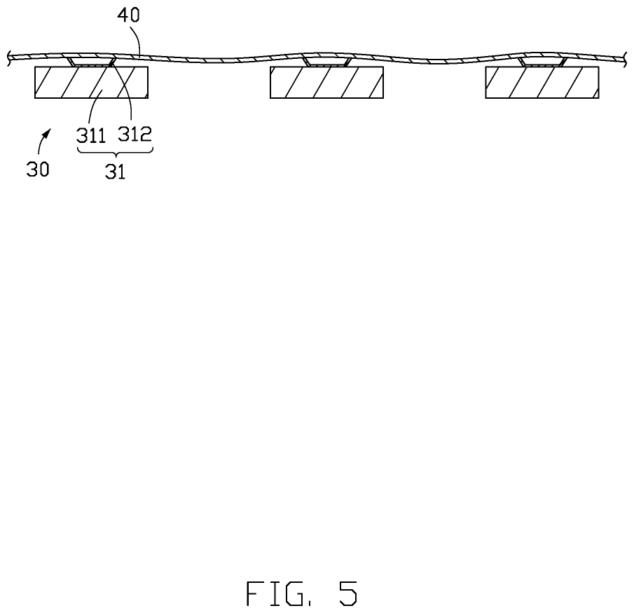

As shown in FIG. 5, in a comparative embodiment, a vacuum suction device 30 includes a plurality of suction heads 31. Each suction head 31 is used to pull a workpiece 40. Each suction head 31 includes a base 311 and a suction nozzle 312 fixed on a surface of the base 311. The surface of the base 311 provided with the suction nozzle 312 is a flat surface. The suction nozzle 312 pulls the workpiece 40, and the workpiece 40 is carried only by the suction nozzles 312, resulting in a small contact area between the workpiece 40 and the vacuum suction device 30. Herein, the force of suction is concentrated on the positions that directly contact the suction nozzles 312, that is, the workpiece can 40 receive uneven forces. The flexibility or outright mass of the workpiece 40 causes parts of the workpiece 40 between adjacent suction nozzles 312 to be recessed toward the suction heads 31, as the workpiece 40 is deformed. In addition, when the vacuum suction device 30 moves the workpiece 40, the workpiece 40 shakes due to uneven force. Deformation of the workpiece 40 is further increased and the accuracy of the subsequent placement position is affected.

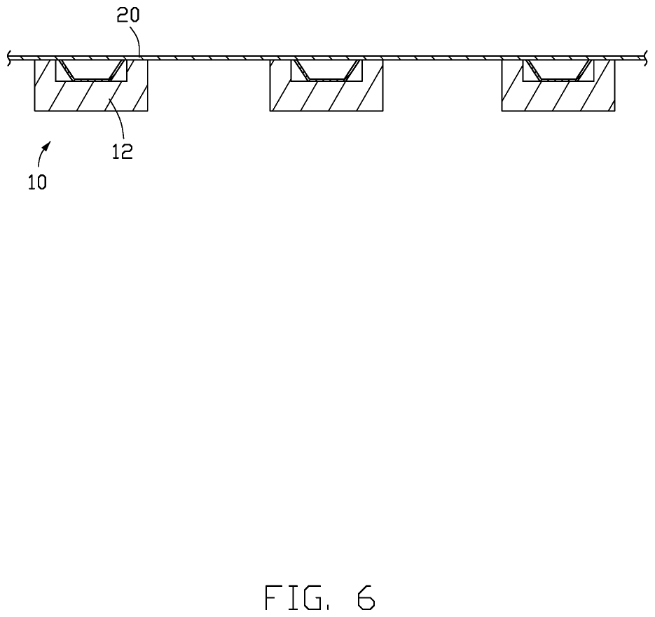

As shown in FIGS. 3 and 6, when the vacuum suction device 10 of an embodiment pulls the workpiece 20, the first surface 1211 of the positioning block 121 in each suction head 12 resists the surface of the workpiece 20 close to the suction heads 12. The overall uniformity of the pulling and holding forces on the workpiece 20 is improved, which is beneficial to maintaining the shape of the workpiece 20. Since the uniformity of the forces on the workpiece 20 is effectively improved, the workpiece 20 remains stable when the vacuum suction device 10 moves the workpiece 20. Jitter and vibration of the workpiece 20 during the transfer process is resolved compared with the comparative example.

The vacuum suction device 10 according to one embodiment includes the positioning block 121, and the positioning block 121 defines the accommodating groove 1212 to accommodate the suction nozzle 122. When the vacuum suction device 10 is not pulling on the workpiece 20, the second opening 1223 of the suction nozzle 122 protrudes to the accommodating groove 1212. When the workpiece 20 moves close to the vacuum suction device 10, the mass of the workpiece 20 causes the suction nozzle 122 to shrink toward the positioning block 121, until the surface of the workpiece 20 close to the positioning block 121 resists the first surface 1211 of the positioning block 121. The uniformity of forces on the workpiece 20 reduces deformities and damage. Stability during the process of transferring the workpiece 20 is maintained, the workpiece 20 is not shaken when the suction nozzle 122 contracts, thereby improving the accuracy of transferring the workpiece 20 to the target position.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A vacuum suction device, comprising:
at least one vacuum generating structure; and
at least one suction head, each of the at least one suction head comprising:
a positioning block, wherein the positioning block has a first surface and a second surface opposite to the first surface, the positioning block defines a through hole extending through the first surface and the second surface, the first surface defines an accommodating groove open to the through hole, the accommodating groove has a bottom wall away from the first surface, the bottom wall defines a first opening aligned with the through hole; and
a suction nozzle at least partially accommodated in the accommodating groove, wherein the suction nozzle has a bottom portion fixed on the bottom wall and a side portion connected to the bottom portion, the side portion defines a second opening protruding from the accommodating groove;
wherein each of the at least one vacuum generating structure is open to the through hole of at least one suction head, so that the suction nozzle sucks or releases a workpiece by applying or releasing a vacuum in the through hole;
when the workpiece is sucked by the suction nozzle, the workpiece abuts against the first surface of the positioning block.

2. The vacuum suction device of claim 1, wherein the side portion of the suction nozzle and the bottom portion of the suction nozzle intersect to form an obtuse angle.

3. The vacuum suction device of claim 1, wherein a material of the suction nozzle is a flexible and deformable material.

4. The vacuum suction device of claim 3, wherein the material of the suction nozzle is silicone or rubber.

5. The vacuum suction device of claim 1, wherein each of the at least one vacuum generating structure comprises a solenoid valve and a connecting pipe connected with the solenoid valve; the connecting pipe is open to the through hole of at least one suction head.

6. The vacuum suction device of claim 1, further comprising at least one transfer arm, wherein each of the at least one transfer arm is provided with the suction head, and the at least one transfer arm is configured to transfer the workpiece sucked by the suction head to a target position.

7. The vacuum suction device of claim 6, wherein the suction head is detachably attached to the transfer arm.

8. The vacuum suction device of claim 6, wherein each of the at least one transfer arm is provided with a plurality of the suction heads, and a distance between any two adjacent ones of the plurality of the suction heads is equal.

9. The vacuum suction device of claim 6, wherein the vacuum suction device comprises a plurality of the transfer arms, and the plurality of the transfer arms is capable of being shifted synchronously to keep relative positions of the plurality of the transfer arms unchanged.

10. The vacuum suction device of claim 9, wherein the plurality of the transfer arms is arranged in parallel, and a distance between any two adjacent ones of the plurality of the transfer arms is equal.

11. The vacuum suction device of claim 6, wherein each of the at least one vacuum generating structure opens to the through hole of the suction head on one of the at least one transfer arm.

12. The vacuum suction device of claim 1, wherein the side portion extends beyond the first surface of the positioning block.

13. The vacuum suction device of claim 1, wherein the bottom portion is a flat plate, and the side portion is curved in an arc shape.

14. The vacuum suction device of claim 13, wherein the bottom portion is substantially circular.

15. The vacuum suction device of claim 1, wherein the accommodating groove has a side wall connected to the bottom wall, and the side wall has a constant height.
